(19) United States
(12) Patent Application Publication
(10) Pub. No.: US 2009/0234574 A1
(43) Pub. Date: Sep. 17, 2009

(54) ROUTING METHOD AND ROUTING DEVICE FOR DETERMINING TARGET ROUTE ACCORDING TO POI DISTRIBUTION

(76) Inventors: Dao-Wen Deng, Hefei (CN); Lu Zhu, Hefei (CN)

Correspondence Address: NORTH AMERICA INTELLECTUAL PROPERTY CORPORATION, P.O. BOX 506, MERRIFIELD, VA, 22116, US

(21) Appl. No.: 12/106,347

(22) Filed: Apr. 21, 2008

(30) Foreign Application Priority Data
Mar. 13, 2008 (CN) 200810081786.9

(51) Int. Cl. G01C 21/00

(52) U.S. Cl. 701/201

(57) ABSTRACT

A routing method determines a route according to a distribution of POIs within a distance extending from the route. The distribution of POIs is derived from a POI density that is calculated by dividing an amount of POIs within the distance extending from a path with a length of the path. The cost value of the path is calculated by multiplying a weighting value to a length of the path, and the weighting value is given corresponding to the density. The route is then determined dependent on a cost value of the route derived by adding the cost values of all paths contained it.

### BACKGROUND

The present invention relates to a routing method and a device thereof, and more particularly, to a routing method for determining a target route according to a POI distribution and the device thereof.

A general vehicle navigation system or a navigation system integrated into a portable device (such as a cell phone, PDA, etc.) is commonly included with a Global Navigation Satellite System (GNSS) and a Graphic Information System (GIS) to provide the user with precise positioning and road inquiry functions. That is, the navigation system is capable of offering a routing function to facilitate a user to get to a destination. For example, users can select the shortest route or the shortest passing time between a starting point and a destination according to the routing function in the navigation system. Moreover, the GIS comprising a lot of point of interest (POI) information, such as shops, gas stations, hospitals, landmarks, or museums in a target area. The user can search for properties including name, address and phone number of a POI. The navigation system can plan a route from the present position determined by the GNSS to a POI selected by the user, display a detailed map as the user moves forward, reroute a new route when the user moves out of the ordinary route, and estimate the required time to arrive at the POI according to the present driving speed.

Although the conventional routing function in the navigation system seems to be feature-rich, it still cannot meet all users' demands such as routing according to a POI distribution. Sometimes, when at lunch time, the user would like to go on a route full with restaurants around, or the user prefers a route with a plenty of shops for shopping. The conventional navigation system, however, can only passively provide related information of a POI, but cannot offer a routing program according to the POI distribution for the user to decide which way to go.

### SUMMARY OF THE INVENTION

According to an exemplary embodiment of the present invention, a routing method for determining a target route from a starting point to an ending point is provided. The routing method includes: obtaining a plurality of candidate paths between the starting point and the ending point from a database; obtaining a POI distribution corresponding to each of the candidate paths; and determining the route having paths selected from the candidate paths according to the detection results.

According to another exemplary embodiment of the present invention, a routing device for determining a target route from a starting point to an ending point is provided. The routing device includes a first storage device, a second storage device, and a routing unit. The first storage device is for storing a database. The second storage device is for storing a routing program including a first program code, a second program code, and a third program code. The routing unit is coupled to the first storage device and the second storage device, and is used for executing the first program code for obtaining a plurality of candidate paths between the starting point and the ending point from the database stored in the first storage device; executing the second program code for obtaining a POI distribution corresponding to each of the candidate paths; and executing the third program code for determining a route having paths selected from the candidate paths according to the detection results.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a method for calculating a POI density within a certain range of a route when a GIS database has connections with a POI database according to an exemplary embodiment of the present invention.

FIG. 2 is a flowchart of a method for calculating the POI density within a certain range of the route when the GIS database has no connections with the POI database according to an exemplary embodiment of the present invention.

FIG. 3 is a detailed flowchart of step 206 in FIG. 2 according to an embodiment of the present invention.

FIG. 4 is a diagram illustrating relationship between a plurality of rectangles and a minimum bounding rectangle in FIG. 3 according to an exemplary embodiment of the present invention.

FIG. 5 is a flowchart illustrating a method of determining a target route from a starting point to an ending point by computing cost values of a plurality of candidate routes according to an embodiment of the present invention.

FIG. 6 is a diagram illustrating a target route displayed on the graphic user interface, where the target route is derived from the routing method.

FIG. 7 is a diagram of a graphical user interface providing user options of selecting routing strategies according to an embodiment of the present invention.

FIG. 8 is a diagram of a graphical user interface providing user options of selecting types of POIs according to an embodiment of the present invention.

FIG. 9 is a diagram of a graphical user interface providing user options for selecting a distance threshold extended from paths according to an embodiment of the present invention.

FIG. 10 is a diagram of a graphical user interface providing user options for selecting routing preference according to an embodiment of the present invention.

FIG. 11 is a block diagram of an electronic device capable of performing a routing function according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

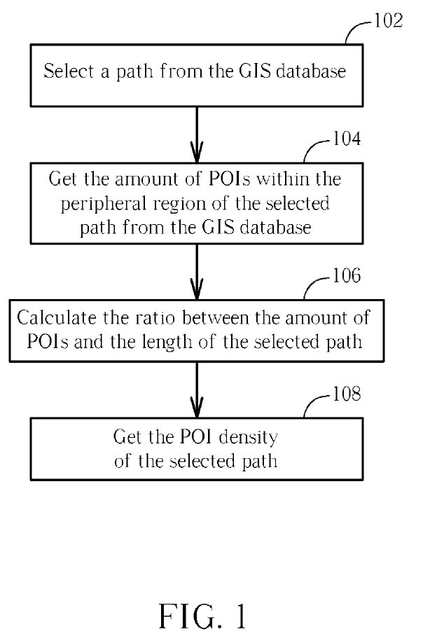

The present invention offers a routing method referred to the POI distribution obtained from a database. There are two kinds of GIS database used in the navigation system, one is configured to have connections between information of roads and peripheral facilities stored in a POI database, and the other is not. Please refer to FIG. 1. FIG. 1 is a flowchart of a method for calculating the POI density within a certain range of the route when the GIS database has connections with the POI database according to an exemplary embodiment of the present invention. Provided that the result is substantially the same, the steps are not required to be executed in the exact order shown in FIG. 1. The exemplary method for calculating the POI density within a certain range of the route includes the following steps:
Step 102: Select a path from the GIS database.
Step 104: Get the amount of POIs within the peripheral region of the selected path from the GIS database.
Step 106: Calculate the ratio between the amount of POIs and the length of the selected path.
Step 108: Get the POI density of the selected path.

In above exemplary embodiment, because the GIS database has already had the connections with the POI database, the information of peripheral facilities can be accessed directly from the POI database. Therefore, only the ratio between the amount of POIs and the length of the path is needed to be computed in order to get the POI density of the path.

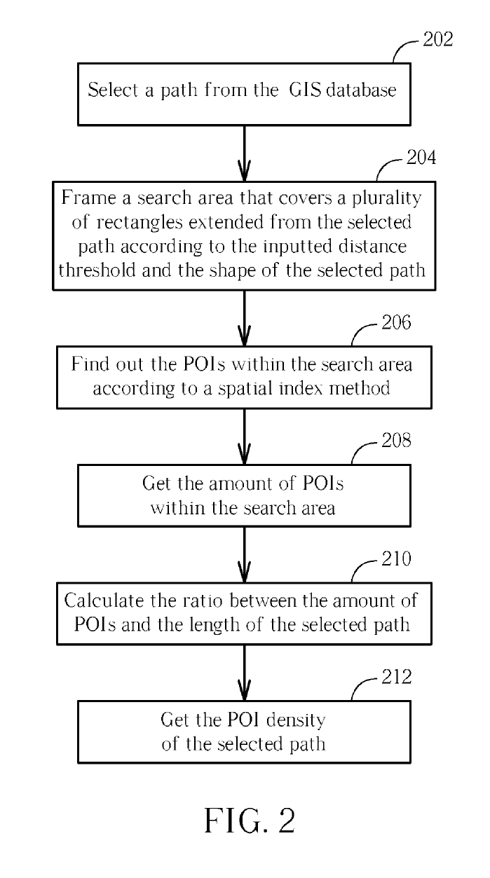

Please refer to FIG. 2. FIG. 2 is a flowchart of a method for calculating the POI density within a certain range of the route when the GIS database has no connections with the POI database according to an exemplary embodiment of the present invention. Provided that the result is substantially the same, the steps are not required to be executed in the exact order shown in FIG. 2. The exemplary method for calculating the POI density within a certain range of the route includes the following steps:
Step 202: Select a path from the GIS database.
Step 204: Frame a search area that covers a plurality of rectangles extended from the selected path according to the inputted distance threshold and the shape of the selected path.
Step 206: Find out the POIs within the search area according to a spatial index method.
Step 208: Get the amount of POIs within the search area.
Step 210: Calculate the ratio between the amount of POIs and the length of the selected path.
Step 212: Get the POI density of the selected path.

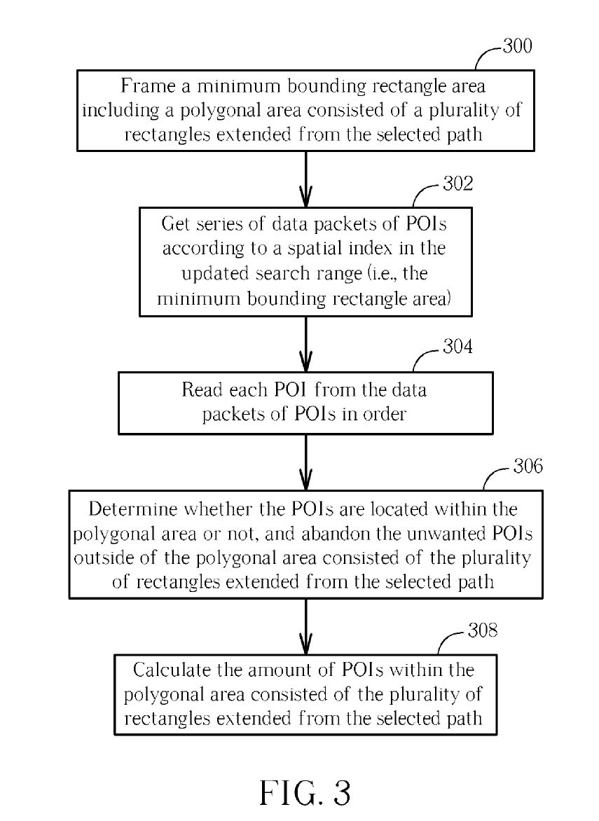

In above exemplary embodiment, because the GIS database does not have the connections with the POI database, rectangle regions extended from each path according to the shape of the path have to be framed first for determining a search area used for deriving the amount of POIs therewithin, then the POI density of the path can be calculated. In FIG. 2, the spatial index method employed in step 206 comprises the following procedures shown in the flowchart of FIG. 3 as follows:
Step 300: Frame a minimum bounding rectangle area including a polygonal area consisted of a plurality of rectangles extended from the selected path.
Step 302: Get series of data packets of POIs according to a spatial index in the updated search range (i.e., the minimum bounding rectangle area).
Step 304: Read each POI from the data packets of POIs in order.
Step 306: Determine whether the POIs are located within the polygonal area or not, and abandon the unwanted POIs outside of the polygonal area consisted of the plurality of rectangles extended from the selected path.
Step 308: Calculate the amount of POIs within the polygonal area consisted of the plurality of rectangles extended from the selected path.

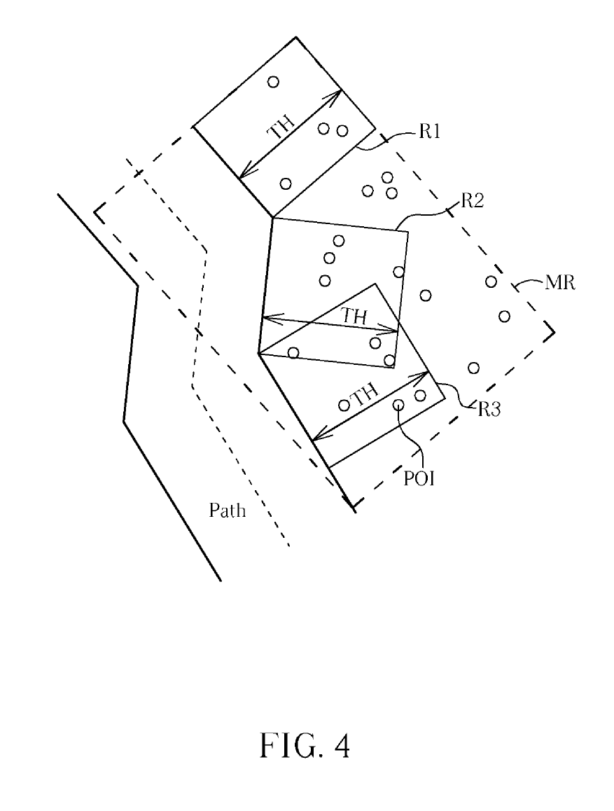

In FIG. 3, a plurality of rectangles are framed by a minimum bounding rectangle for simplifying the calculation of counting the amount of POIs within the polygonal area consisted of the plurality of rectangles extended from the selected path. FIG. 4 is a diagram illustrating the relationship between the plurality of rectangles and the minimum bounding rectangle in FIG. 3 according to an exemplary embodiment of the present invention. In this example, there are three rectangles R1, R2, R3 extended from the selected path according to a distance threshold (e.g., 50 meters) TH, and a minimum bounding rectangle MR, including the areas of the rectangles R1, R2, R3, is determined accordingly. But, because the minimum bounding rectangle might be bigger than the polygon region formed by the plurality of rectangles; that is, some of the counted POIs are probably located outside the plurality of rectangle regions, therefore a re-check action should be done according to the coordinates of the POIs to get rid of the unwanted POIs, as shown in step 306 in FIG. 3. Please note that the example shown in FIG. 4 is for illustrative purposes only, and is not meant to be limitations of the present invention. In other words, the total amount of rectangles extended from the selected path varies according to design requirements. The more the rectangles extended from the selected path, the higher the accuracy of getting the amount of POIs within the search area.

From the above, the POI density of each path included in a route can be derived after steps 100 to 108 in a case where the GIS database has connections with the POI database, or derived after steps 200 to 212 in another case where the GIS database has no connections with the POI database. After deriving the POI density of each path, a cost value of each path can be counted as the multiplication result of the length of the path and a weighting value of each path. Based on the calculation of the conventional routing method, the weighting value of a route in the present invention is set corresponding to the POI density of the route for indicating the POI distribution and the types of the POIs around the route. The weighting values are derived from experiments and tests. For example, provided that a route with a minimum cost value is selected as the target route, when a user tends to go on a prosperous route, then the weighting value of a path with a higher POI density in its neighborhood will be set by a smaller value accordingly, and vice versa, in order to meet the inquiry raised by the user.

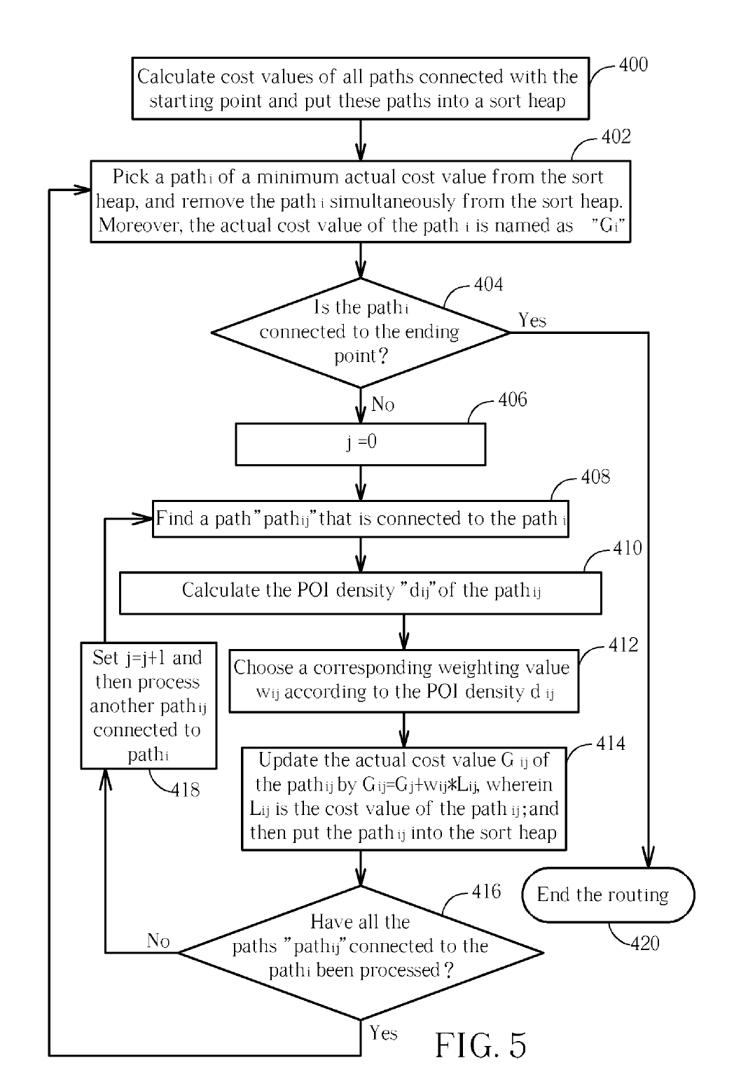

Finally, a cost value of a route can be obtained by summing up the cost values of all paths contained in the route. The detailed description of the above mentioned procedures is illustrated in the flowchart FIG. 5. FIG. 5 is a flowchart illustrating a method of determining a target route from a starting point to an ending point by computing cost values of a plurality of candidate routes according to an embodiment of the present invention. Provided that the result is substantially the same, the steps are not required to be executed in the exact order shown in FIG. 5. The method of determining the target route includes the following steps:
Step 400: Calculate cost values of all paths connected with the starting point and put these paths into a sort heap.
Step 402: Pick a pathᵢ of a minimum actual cost value from the sort heap, and remove the pathᵢ simultaneously from the sort heap. Moreover, the actual cost value of the pathᵢ is named as “Gᵢ”.
Step 404: Determine whether the pathᵢ is connected to the ending point. If “yes”, then go to step 420; otherwise, go to step 406.
Step 406: Set j=0.
Step 408: Find a path “pathᵢⱼ” that is connected to the selected paths.
Step 410: Calculate the POI density “dᵢⱼ” of the pathᵢⱼ.
Step 412: Choose a corresponding weighting value wᵢⱼ according to the POI density dᵢⱼ.
Step 414: Update the actual cost value Gᵢⱼ of the pathᵢⱼ by Gᵢⱼ=Gⱼ+wᵢⱼ*Lᵢⱼ, wherein Lᵢⱼ is the cost value of the pathᵢⱼ; and then put the pathᵢⱼ into the sort heap.
Step 416: Determine whether all the paths “pathᵢⱼ” connected to the pathᵢ have been processed. If “yes”, go to step 402; otherwise, go to step 418.
Step 418: Set j=j+1 and then go to step 408 for processing another pathᵢⱼ connected to paths.
Step 420: End the routing.

In FIG. 5, the flow first selects all paths connected to the starting point set by the user and puts all the initially selected paths into a sort heap stored in, for example, a memory, and then chooses the path having a minimum actual cost value from the sort heap. If the selected path having the minimum actual cost value is the last path of a route that is connected to the ending point, and then the routing procedure is completed as the target route with the minimum cost value has been identified successfully; otherwise, the flow continues calculating cost values of any next paths following the selected path currently having a minimum cost value (i.e., a minimum accumulated cost value) by multiplying the length of each next path with a weighting value corresponding to the POI density found through the steps in FIG. 1 or FIG. 2. The flow of FIG. 5 adds the calculation results to the actual cost value of the selected path to update an accumulated cost value of each next path (i.e., pathᵢⱼ) following the selected path (i.e., pathᵢ). In other words, Gᵢⱼ=Gⱼ+wᵢⱼ*Lᵢⱼ. It should be noted that the processed paths (i.e., pathᵢⱼ) will be added to the sort heap, and the path selected in step 402 will be removed from the sort heap. After all the paths “pathᵢⱼ” connected to the instantly selected path “pathᵢ” have been processed, the flow compares the cost values of all paths currently in the sort heap again to re-choose the path having the minimum cost value, which means that if the cost values of the paths “pathᵢⱼ” lately added to the sort heap is not the minimum compared with the cost values of other paths in the sort heap, a new path selected in step 402 will be the path with the minimum cost value among the other paths in the sort heap rather than the path with the minimum cost value among the paths “pathᵢⱼ” lately added to the sort heap.

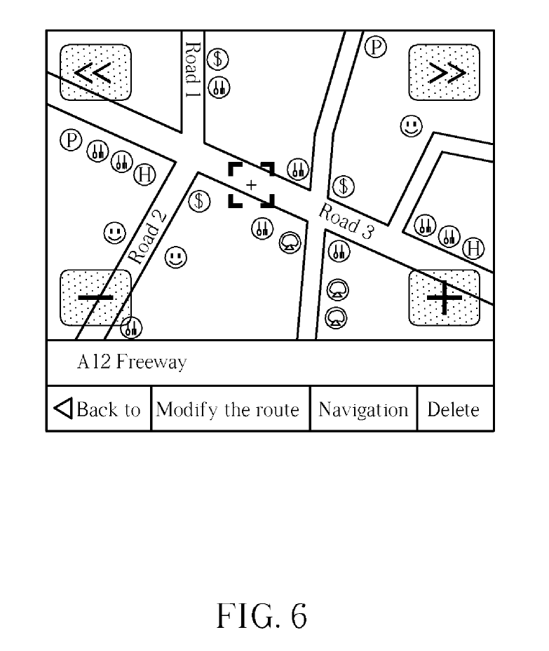

For example, paths L1, L2, L3 each have one end being the starting point, and paths L1, L2, L3 are added to a sort heap. The cost values C1, C2, C3 are therefore compared to find the minimum. If the cost value C1 is the minimum value, the path L1 is selected and removed from the sort heap. Suppose that there are four paths L11, L12, L13, L14 following the selected path L1. The cost values C11, C12, C13, C14 of the paths L11, L12, L13, L14 are computed and added to the cost value C1 of the selected path L1 to derive accumulated cost values of the paths L11, L12, L13, L14. As a result, the paths L11, L12, L13, L14 with actual cost values C1+C11, C1+C12, C1+C13, C1+C14 are added to the sort heap. It should be note that the sort heap currently has paths L2, L3, L11, L12, L13, L14 included therein. Next, the cost values of the paths L2, L3, L11, L12, L13, L14 are compared to find a path with a minimum actual cost value. The above flow continues till a selected path having a minimum actual cost value has one end being the ending point. This implies that the last path of a target route having a minimum cost value has been found. Therefore, based on the search history, the target route having a minimum cost value can be determined successfully. FIG. 6 is a diagram illustrating a target route displayed on the graphic user interface, where the target route is derived from the routing method. It should be note that the flow shown in FIG. 5 is for illustrative purposes only. Any algorithms referring to the POI distribution for finding the target route all obey the spirit of the present invention. For example, another embodiment of the present invention can route according to the POI numbers derived from the database within an area from the target route in a predetermined distance, and the detailed steps of this embodiment are similar to the above mentioned one, therefore are omitted here for brevity.

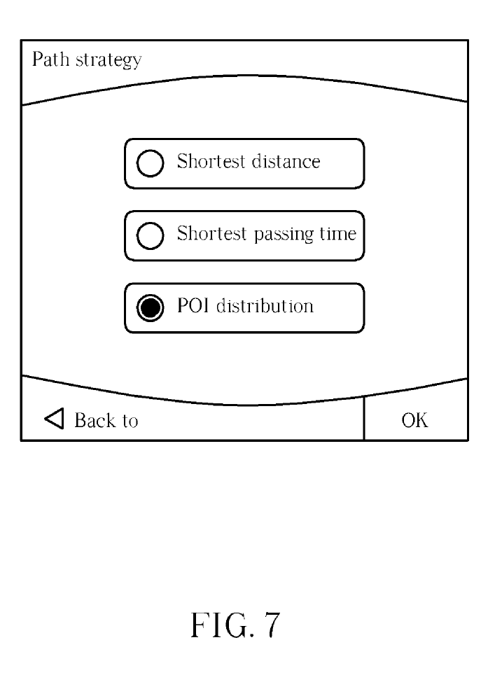

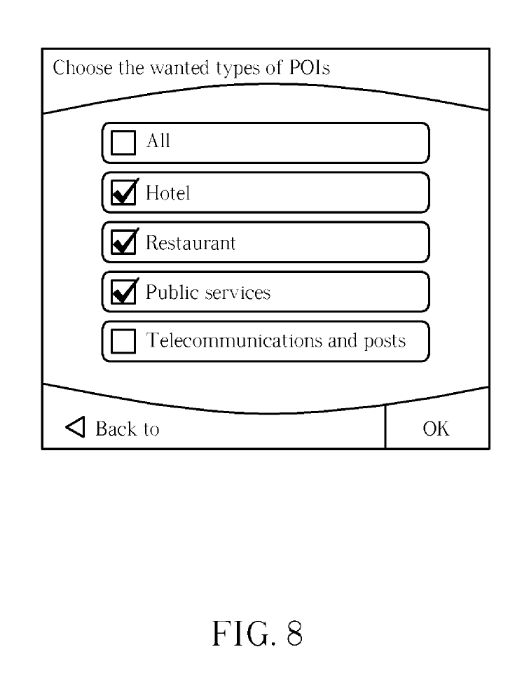

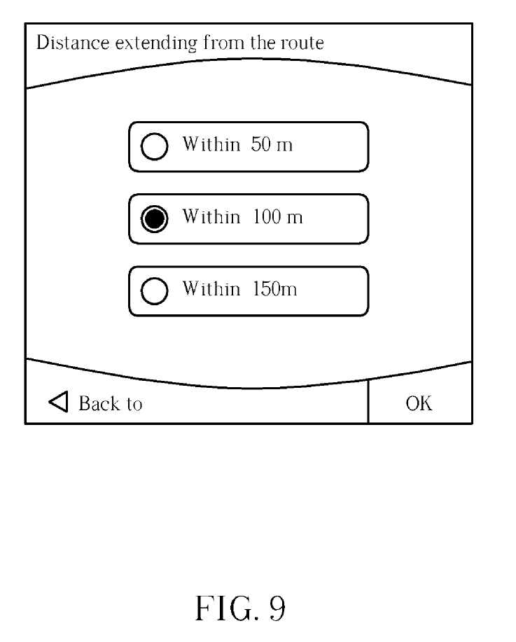

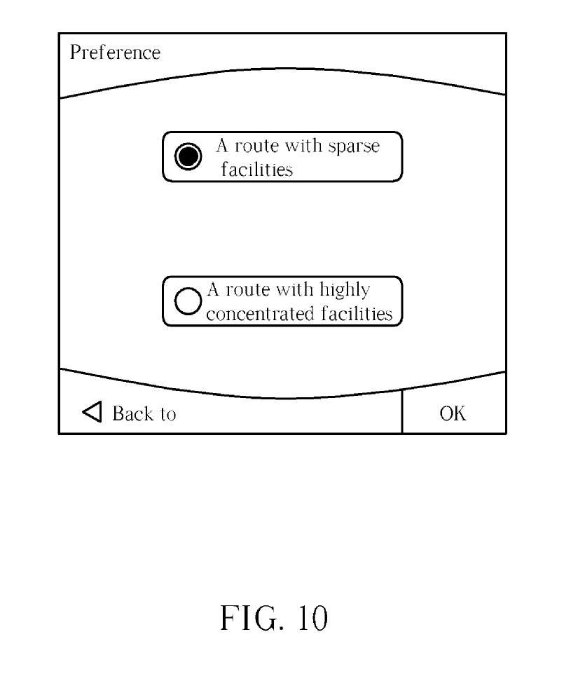

The user can input the instructions for operating the routing system through some graphical interfaces. Please refer to FIG. 7 through FIG. 10. In FIG. 7, the user chooses a routing method based on the POI distribution among three options: the shortest distance, the shortest time, and the POI distribution. In FIG. 8, the user further chooses the wanted types of POIs (one type, several types, or all types) listed in the menu including options of selecting all types, hotels, restaurants, public services, and telecommunications and posts. Moreover, the user can select the farthest distance (i.e., the aforementioned distance threshold) between the POI and the route, for example, within a distance extending from the path of 50 m, 100 m, or 150 m as shown in FIG. 9. In addition, the user confirms that he/she would like to pass a route with sparse POIs or a route with highly concentrated POIs as shown in FIG. 10. It should be noted that the options shown in the user interfaces illustrated in FIGS. 7-10 are for illustrative purposes only, and are not meant to be limitations of the present invention.

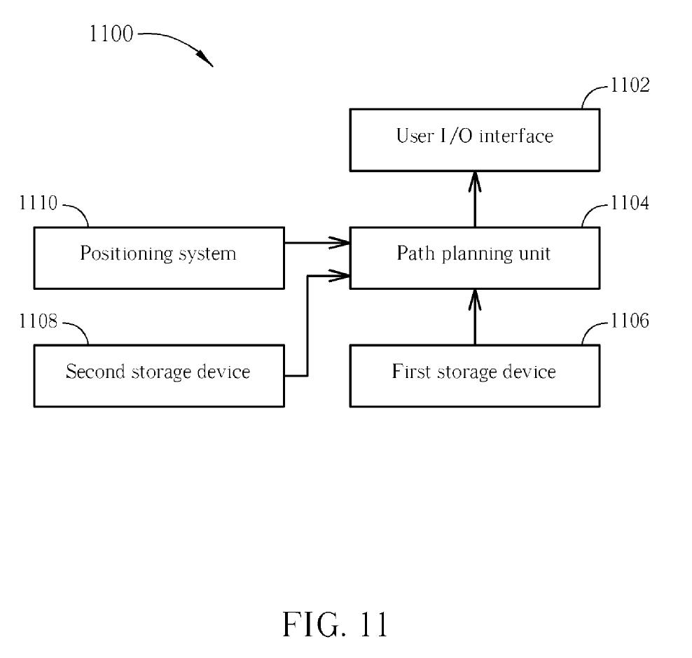

Please refer to FIG. 11. FIG. 11 is a block diagram of an electronic device capable of performing the above mentioned routing method according to an exemplary embodiment of the present invention. The electronic device 1100 includes, but is not limited to, an I/O interface 1102, a routing unit 1104, a first storage device 1106, a second storage device 1108, and a positioning system 1110. The I/O interface 1102 acts as a user interface, and is for receiving user commends for a routing procedure and showing a graphical interface to the user. The first storage device 1016 is for storing a database such as a GIS database, and the second storage device 1108 is for storing program codes for performing the routing function mentioned above. The routing unit 1104 (e.g., a microprocessor) is for executing the routing program stored in the second storage device. For example, the routing program includes a first program code, a second program code, and a third program code. The routing unit 1104 therefore executes the first program code for searching a plurality of candidate routes connecting the starting point and the ending point from the database stored in the first storage device; executing the second program code for detecting a POI distribution corresponding to each of the candidate routes to generate a plurality of detection results; and executing the third program code for selecting the target route from the candidate routes according to the detection results. As the operation of the routing method is detailed above, further description directed to execution of the routing program is omitted here for the sake of brevity.

The positioning system 1110 (e.g., a global navigation satellite system) is for locating the present position of the electronic device 1100. For example, the present position of the electronic device 1100 is directly used as the starting point of a target route to be planned by the routing procedure. However, the above-mentioned starting point is not limited to be the present position of the electronic device (i.e., the present position of the user). In addition, please note that implementing the disclosed routing method in a navigation system is only an example, and is not meant to be a limitation of the present invention. That is, the routing can be applied to any application having the need of planning a route from a starting point to an ending point. Furthermore, the user I/O interface 1102 is not only confined to the graphical user interface as mentioned above. In an alternative design, the user I/O interface can be implemented using a video interface, an audio interface, or a combination thereof. It should be noted that the databases (e.g., the GIS database) can be an internal database stored in the first storage device 1106 or a database downloaded from an internet server into the first storage device 1106. In the exemplary embodiment shown in FIG. 11, the first storage device 1106 and the second storage device 1108 are shown as separate components. However, in an alternative design, the first storage device 1106 and the second storage device 1108 could be two blocks within the same storage device.

Briefly summarized, the present invention can meet the user's inquiry of searching a route according to the POIs distribution to supplement the insufficiency in conventional routing functions.

Those skilled in the art will readily observe that numerous modifications and alterations of the device and method may be made while retaining the teachings of the invention.

What is claimed is:

1. A routing method for determining a route from a starting point to an ending point, comprising:
obtaining a plurality of candidate paths between the starting point and the ending point from a database;
obtaining a POI (point of interest) distribution corresponding to each of the candidate paths; and
determining the route having paths selected from the candidate paths according to the detection results.

2. The method of claim 1, wherein the step of obtaining a POI distribution corresponding to each of the candidate paths comprises:
determining a POI number of POIs each located within a distance threshold from the candidate path; and
generating the POI distribution of the candidate path according to the POI number.

3. The method of claim 1, wherein the step of obtaining a POI distribution corresponding to each of the candidate paths comprises:
determining a POI number of POIs each located within a distance threshold from the candidate path;
calculating a POI density of the candidate path according to the POI number; and
generating the POI distribution according to the POI density value of the candidate path.

4. The method of claim 3, wherein the step of calculating the POI density of the candidate path comprises:
calculating a ratio of the POI number to a length of the candidate path to set the POI density.

5. The method of claim 1, wherein the step of obtaining a POI distribution corresponding to each of the candidate paths comprises:
determining a POI number of POIs each located within a distance threshold from the candidate path;
calculating a POI density of the candidate path according to the POI number;
determining a weighting factor corresponding to the POI density of the candidate path;
calculating a cost value of the candidate path according to a multiplication result of the weighting factor and a length of the candidate path; and
generating the POI distribution according to the cost value of the candidate path.

6. The method of claim 5, wherein the step of determining the POI number of POIs comprises:
determining a search area by extending the candidate path with a plurality of rectangles according to the distance threshold and the shape of the path; and
searching any POI located within the search area from the database to determine the POI number.

7. The method of claim 6, wherein the search area is a minimum bounding rectangle containing a polygonal area formed by the rectangles.

8. A routing device for determining a target route from a starting point to an ending point, comprising:
a first storage device, for storing a database;
a second storage device, for storing a routing program including a first program code, a second program code, and a third program code; and
a routing unit, coupled to the first storage device and the second storage device, for executing the first program code for obtaining a plurality of candidate paths between the starting point and the ending point from the database stored in the first storage device; executing the second program code for obtaining a POI distribution corresponding to each of the candidate paths; and executing the third program code for determining a route having paths selected from the candidate paths according to the detection results.

9. The routing device of claim 8, wherein the routing unit executes the second program code to obtain a POI distribution corresponding to each of the candidate paths by:
determining a POI number of POIs each located within a distance threshold from the candidate paths, and generating the POI distribution of the candidate path according to the POI number.

10. The routing device of claim 8 wherein the routing unit executes the second program code to obtain a POI distribution corresponding to each of the candidate paths by:
determining a POI number of POIs each located within a distance threshold from the candidate path;
calculating a POI density of the candidate path according to the POI number; and
generating the POI distribution according to the POI density value of the candidate path.

11. The routing device of claim 10 wherein the routing unit executes the second program code to calculate the POI density of the candidate path by calculating a ratio of the POI number to a length of the candidate path to set the POI density.

12. The routing device of claim 8, wherein the routing unit executes the second program code to obtain a POI distribution corresponding to each of the candidate paths by:
determining a POI number of POIs each located within a distance threshold from the candidate path;
calculating a POI density of the candidate path according to the POI number;
determining a weighting factor corresponding to the POI density of the candidate path;
calculating a cost value of the candidate path according to a multiplication result of the weighting factor and a length of the candidate path; and
generating the POI distribution according to the cost value of the candidate path.

13. The routing device of claim 12, wherein the routing unit executes the second program code to determine the POI number of POIs by:
determining a search area by extending the candidate path with a plurality of rectangles according to the distance threshold and the shape of the path; and
searching any POI located within the search area from the database to determine the POI number.

14. The routing device of claim 13, wherein the search area is a minimum bounding rectangle containing a polygonal area formed by the rectangles.
